(19) United States
(12) Patent Application Publication
(10) Pub. No.: US 2026/0252985 A1
(43) Pub. Date: Aug. 27, 2026

(54) DYNAMIC TIMETABLE MANAGEMENT SYSTEM AND DYNAMIC TIMETABLE MANAGEMENT METHOD AND TRAFFIC SOLUTION SYSTEM USING DYNAMIC TIMETABLE MANAGEMENT SYSTEM

(71) Applicant: Hitachi, Ltd., Tokyo (JP)

(72) Inventors: Yukiko KINOSHITA, Tokyo (JP); Rieko OTSUKA, Tokyo (JP)

(21) Appl. No.: 18/577,807

(22) PCT Filed: Mar. 24, 2022
(86) PCT No.: PCT/JP2022/013889

§ 371 Date: Jan. 9, 2024

(30) Foreign Application Priority Data
Aug. 20, 2021 (JP) 2021-134870

(51) Int. Cl. G06Q 10/0631; G06Q 50/40

(52) U.S. Cl. CPC G06Q 10/06312; G06Q 50/40

(57) ABSTRACT

In real time, operation predictions are provided that are closer to actual situations in consideration of knock-on delays caused by the influence of congestion and delays on each other. A dynamic timetable management system acquires congestion prediction and has a probability operation prediction generation unit which generates probability operation prediction which expresses, on the basis of an operation situation, at least one of stop hour/minute and travel hour/minute included in a line as a probability distribution; and a dynamic timetable creation unit which creates a dynamic timetable obtained by rewriting the time of arrival at a station on the line and the time of departure from the station on the basis of a rewritten time determined through use of the congestion prediction and the probability operation prediction.

The dynamic timetable creation unit uses a cumulative probability calculated on the basis of the congestion prediction to determine the rewritten time.

### TECHNICAL FIELD

The present invention relates to a dynamic timetable management system, a dynamic timetable management method, and a traffic solution system using the dynamic timetable management system.

### BACKGROUND ART

Elimination of delays caused by congestion has become an issue mainly in railways of metropolitan areas, and provision of delay information in real time has been demanded in many traffic solution systems such as route guidance systems and onboard information management systems.

Also, delays caused by congestion result in further congestion. Like this, it has been known that congestion and delays have influence on each other.

PTL 1 provides a system that implements train schedule prediction processing corresponding to train schedules operated on the scale of private railways and that is, from an aspect a user interface, easily operated by an operation commander.

PTL 2 enables, on the basis of operation situations fluctuating in real time, route guidance that less fluctuates even when generating operation predictions from moment to moment.

### CITATION LIST

### Patent Literature

### PTL 1

Japanese Patent Application Publication No. 2012-245801

### PTL 2

Japanese Patent Application Publication No. 2021-49863

### SUMMARY OF INVENTION

### Technical Problem

In PTL 1, although current congestion is input to predict delays, only most-recent actual congestion information is taken into consideration, and meanwhile, the influence of delays caused by the mutual interaction between congestion and the delays is not taken into consideration.

Further, PTL 2 provides a timetable with a time allowance for each passenger at the time of route guidance, but is specialized in individual route guidance and is not applicable to traffic solution systems such as onboard information management systems that target at all passengers. Besides, the influence of delays caused by the mutual interaction between congestion and the delays is not taken into consideration.

The present invention has been made in view of the above problems, and has an object of providing a dynamic timetable management system, a dynamic timetable management method, and a traffic solution system using the dynamic timetable management system capable of providing operation predictions closer to actual situations in real time in consideration of the influence of delays caused by the mutual interaction between congestion and the delays.

### Solution to Problem

In order to solve the above problems, a dynamic timetable management system according to an aspect of the present invention is a dynamic timetable management system generating a dynamic timetable reflecting an operation situation and a congestion prediction of a movable body in a line including a plurality of stops, the dynamic timetable management system including: a congestion information acquisition unit configured to acquire the congestion prediction; a probability operation prediction generation unit configured to generate, on a basis of the operation situation, a probability operation prediction in which at least one of a dwell time and a travel time included in the line is expressed as a probability distribution; and a dynamic timetable creation unit configured to create, on a basis of a rewritten time point set using the congestion prediction and the probability operation prediction, the dynamic timetable in which a time point of arrival at each of the stops and a time point of departure from each of the stops included in the line are rewritten, wherein the dynamic timetable creation unit is configured to determine the rewritten time point using a cumulative probability calculated on a basis of the congestion prediction.

### Advantageous Effects of Invention

According to the present invention, a dynamic timetable management system, a dynamic timetable management method, and a traffic solution system using the dynamic timetable management system capable of providing operation predictions closer to actual situations in real time in consideration of the influence of delays caused by the mutual interaction between congestion and the delays can be realized.

### BRIEF DESCRIPTION OF DRAWINGS

FIG. 1 shows a network configuration example of a dynamic timetable management system and relevant systems according to an embodiment.

FIG. 2 shows a hardware configuration example of the dynamic timetable management system according to the embodiment.

FIG. 3 is a flowchart of a dynamic timetable generation unit of the dynamic timetable management system according to the embodiment.

FIG. 4 is a flowchart of a dynamic timetable creation unit of the dynamic timetable management system according to the embodiment.

FIG. 5 shows a data structure example of congestion prediction information of the dynamic timetable management system according to the embodiment.

FIG. 6 shows a data structure example of a probability operation prediction of the dynamic timetable management system according to the embodiment.

FIG. 7 shows a data example of congestion prediction information of the dynamic timetable management system according to the embodiment.

FIG. 8 shows a data example of congestion prediction information of the dynamic timetable management system according to the embodiment.

FIG. 9 is a graph for describing an example of a written time point calculation method of the dynamic timetable management system according to the embodiment.

FIG. 10 is a table for describing an example of a cumulative probability calculation method of the dynamic timetable management system according to the embodiment.

FIG. 11 is a graph for describing an example of a cumulative probability calculation method of the dynamic timetable management system according to the embodiment.

FIG. 12 shows an example of parameters necessary for calculating a cumulative probability of the dynamic timetable management system according to the embodiment.

FIG. 13 is a table for describing an example of a cumulative probability calculation method of the dynamic timetable management system according to the embodiment.

FIG. 14A shows a data structure example of a distribution timetable of the dynamic timetable management system according to the embodiment.

FIG. 14B shows a data structure example of a distribution timetable of the dynamic timetable management system according to the embodiment.

FIG. 15 is a sequence diagram of a user terminal, a route guidance system, and a distribution unit in a traffic solution system using the dynamic timetable management system according to the embodiment.

FIG. 16 is a flowchart of a recommended route generation unit of the route guidance system in the traffic solution system using the dynamic timetable management system according to the embodiment.

FIG. 17 shows an example of an input screen of a user terminal coupled to the route guidance system in the traffic solution system using the dynamic timetable management system according to the embodiment.

FIG. 18 shows an example of an output screen of a user terminal coupled to the route guidance system in the traffic solution system using the dynamic timetable management system according to the embodiment.

FIG. 19 shows an example of an input/output screen of a user terminal coupled to an onboard information management system in the traffic solution system using the dynamic timetable management system according to the embodiment.

FIG. 20 is an input/output screen of a user terminal coupled to a train schedule planning support system in the traffic solution system using the dynamic timetable management system according to the embodiment.

### DESCRIPTION OF EMBODIMENTS

Hereinafter, embodiments of the present invention will be described with reference to the drawings. Note that the following embodiments do not intend to limit the invention according to claims, and various elements and all the combinations of the elements described in the embodiments are not always essential for the solving means of the invention.

Note that parts having the same functions are denoted by the same symbols in figures describing the embodiments, and their repetitive descriptions will be omitted.

Further, an expression such as “xxx data” will be used as an example of information in some cases in the following descriptions, but information may have any data structure. That is, “xxx data” can be called an “xxx table” to indicate that information does not depend on a data structure. Moreover, “xxx data” will be simply called “xxx” in some cases. Further, the configuration of each information will be given as an example in the following descriptions, but the information may be held in a divided state or a combined state.

Note that processing will be described using a “program” as a subject in the following descriptions in some cases. When run by a processor (for example, a CPU (Central Processing Unit) ), the program performs prescribed processing appropriately using a storage resource (for example, a memory) and/or a communication interface device (for example, a port). Therefore, the program may serve as the subject of the processing. The processing described using the program as the subject may be regarded as processing performed by the processor or a computer having the processor.

Note that when an operating subject is written as an “oo unit” in the following descriptions, it is indicated that a processor reads a processing content of the “oo unit” that is a program from a memory and realizes the function (that will be described in detail later) of the “oo unit” after loading the read processing content into the memory.

A dynamic timetable management system according to the present embodiment has the following configurations as an example.

The purpose of the present embodiment is to provide a dynamic timetable management system and a dynamic timetable management method that provide operation predictions closer to actual situations in real time in consideration of the influence of delays caused by the mutual interaction between congestion and the delays in order to provide traffic solutions satisfied by both passengers and traffic service providers such as solutions with which the passengers are enabled to grasp influence on their schedules caused by the delays and the traffic service providers are enabled to perform operations to eliminate the delays even when the delays are caused by congestion.

The dynamic timetable management system according to the present embodiment is a dynamic timetable management system that generates a timetable reflecting congestion prediction information on a movable body in a line including a plurality of stops, the dynamic timetable management system including: a probability operation prediction generation unit that generates operation prediction data in which each time point (such as a dwell time and a travel time) in an operation is expressed as a probability distribution; and a dynamic timetable creation unit that sets a rewritten time point from the operation prediction data and a cumulative probability and creates a timetable in which an arrival time at each of the stops and a departure time point from each of the stops included in the line are rewritten on the basis of the rewritten time point, wherein the cumulative probability indicates a cumulated probability in the probability distribution, and is calculated in consideration of the influence of a delay on the basis of a congestion fluctuation rate for each time unit obtained from the congestion prediction information.

According to the present embodiment, operation predictions closer to actual situations in consideration of the influence of delays caused by congestion are performed in real time, whereby, when delays are caused by congestion, passengers are enabled to quantitatively grasp influence on their future schedules in unknown places or traffic service providers are enabled to propose solutions to eliminate the delays. As a result, provision of traffic solutions satisfied by both the passengers and the traffic service providers are made possible.

Hereinafter, the dynamic timetable management system according to the present embodiment and a traffic solution system using the dynamic timetable management system will be described on the basis of the drawings. Here, a description will be given using a railway as a public transportation system. Accordingly, a stop and a movable body in the claims will be described as a station and a train, respectively.

Note that the present embodiment is applicable to public transportation vehicles that operate on preset routes on the basis of timetables, and is not limited to railways.

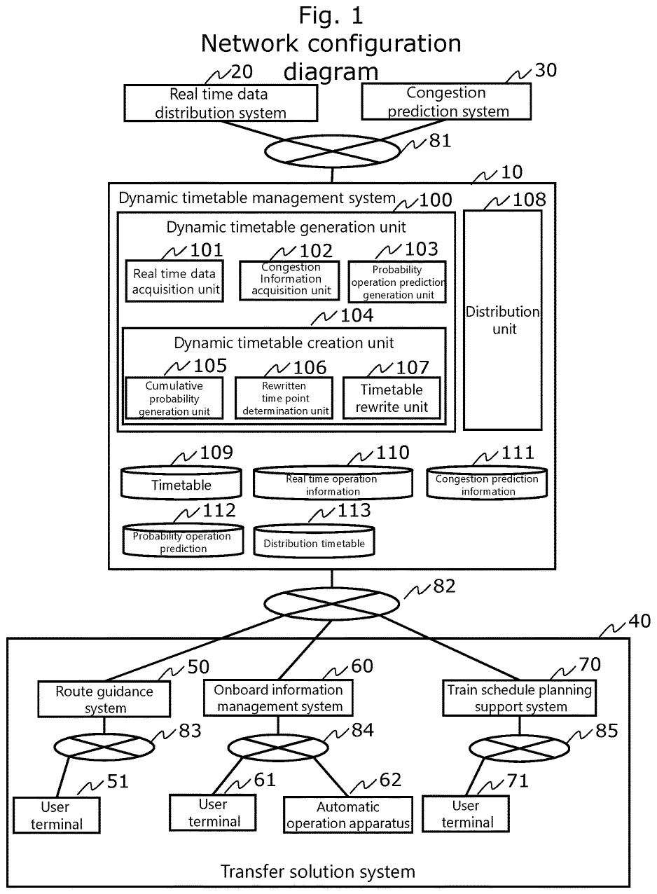

FIG. 1 shows a block diagram of a dynamic timetable management system 10 according to the present embodiment and relevant systems coupled to the dynamic timetable management system 10.

The dynamic timetable management system 10 is coupled to a real time data distribution system 20 and a congestion prediction system 30 via a communication network 81. These systems are systems that distribute data necessary for the dynamic timetable management system 10. Further, the dynamic timetable management system 10 is coupled to a traffic solution system 40 via a communication network 82.

The traffic solution system 40 indicates a general system that provides solutions in a transportation field. However, a route guidance system 50, an onboard information management system 60, and a train schedule planning support system 70 are described as an example in the present embodiment.

The route guidance system 50 is coupled to a user terminal 51 via a communication network 83, the onboard information management system 60 is coupled to a user terminal 61 and an automatic operation apparatus 62 via a communication network 84, and the train schedule planning support system 70 is coupled to a user terminal 71 via a communication network 85.

The communication networks 81, 82, 83, 84, and 85 may be common communication networks or networks using different protocols. Further, the communication networks 81, 82, 83, 84, and 85 may be wired networks or wireless networks.

The real time data distribution system 20 is a system that distributes real time data relating to the operation of a public transportation system such as a railway and a bus to the outside as needed. The real time data distributed by the real time data distribution system 20 includes, for example, operation information data. The operation information data is data including a delay time caused in a line at a certain time point, a reason for a delay, or the like. The real time data distribution system 20 coupled to the dynamic timetable management system 10 may include one real time data distribution system or a plurality of real time data distribution systems.

The congestion prediction system 30 is a system that simulates a people flow of future railway users on the basis of, for example, timetable data or OD data, and that predicts congestion of each train or each station. Here, the OD data is data in which departure stations and destination stations of all moving passengers are combined together. The OD data may include the departure stations and movement routes to the destination stations, or the like. Further, the congestion prediction system 30 may use, as the timetable data, a timetable (hereinafter called a “static timetable”) that is planned by a service provider of a public transportation system about several times a year, may predict congestion in accordance with a current situation using a timetable reflecting real time data distributed by the real time data distribution system 20, or may predict congestion considering a previous delay using a timetable (hereinafter called a “dynamic timetable”) in consideration of the influence of a delay generated by the dynamic timetable management system 10.

The route guidance system 50 indicates a search display system for a timetable such as, for example, a technology disclosed in Japanese Patent Application Laid-open No. 2000-20590. Specifically, the route guidance system 50 indicates a system that provides recommended route guidance on the basis of a route search condition (for example, a departure station, a destination station, a use date and time, or the like) received from the user terminal 51. In the present embodiment, the route guidance system 50 can generate a recommended route on the basis of a dynamic timetable generated by the dynamic timetable management system 10, besides performing route guidance using a static timetable. The details of generation of a recommended route based on a dynamic timetable will be described later.

The route guidance system 50 may perform route guidance corresponding to a route guidance request transmitted from the user terminal 51 at any timing, or may automatically update guidance at timing defined in advance. Alternatively, the route guidance system 50 may perform route guidance at the timing when a dynamic timetable is received by the route guidance system 50 after the dynamic timetable management system 10 distributes the dynamic timetable by PUSH type distribution.

Further, the user terminal 51 is not limited to a terminal personally owned by a general passenger, but may be a terminal used in an operation such as transfer guidance for passengers by a service provider that provides a public transportation system. Examples of the user terminal 51 include a mobile phone (including a so-called smart phone), a mobile information terminal, a so-called wearable type terminal such as a glasses type and a wristwatch type, and a personal computer such as a notebook type, a tablet type, and a desktop type. The user terminal 51 may be a guidance display or an information board installed in a station yard when the user terminal 51 is a terminal used as an operation by a service provider. The route guidance system 50 is connectable to a plurality of the user terminals 51.

The onboard information management system 60 indicates a system using a railway vehicle operation support apparatus and a railway vehicle operation support method such as, for example, a technology disclosed in Japanese Patent Application Laid-open No. 2017-30473. In the present embodiment, the onboard information management system 60 can create, by proposing a travel time on the basis of a dynamic timetable generated by the dynamic timetable management system 10 as needed, operation support information with an eye to elimination of the influence of a delay caused by congestion.

The user terminal 61 is not limited to an onboard apparatus used by an onboard operator but may be a terminal used by the operator. In this case, various terminals are assumed like the user terminal 51. The onboard information management system 60 is connectable to a plurality of the user terminals 61.

Further, the onboard information management system 60 is also capable of being coupled to a plurality of the automatic operation apparatuses 62. The automatic operation apparatuses 62 perform an automatic operation of a vehicle on the basis of operation support information received here.

The train schedule planning support system 70 is a system that supports creation of a basic train schedule in train schedule revision carried out about several times a year. In the present embodiment, the train schedule planning support system 70 proposes a dwell time at each station or a travel time between stations considering the influence of a delay caused by congestion and supports planning of a basic train schedule on the basis of a dynamic timetable generated by the dynamic timetable management system 10. At this time, the dynamic timetable management system 10 may use actual operation record data for several days instead of the real time operation information 110.

Further, a terminal used by a railway sales department is assumed as the user terminal 71, and various terminals are assumed like the user terminal 51. The train schedule planning support system 70 is connectable to a plurality of the user terminals 71.

The dynamic timetable management system 10 is coupled to the various systems of the traffic solution system 40 as described above to obtain a utilization destination of a dynamic timetable.

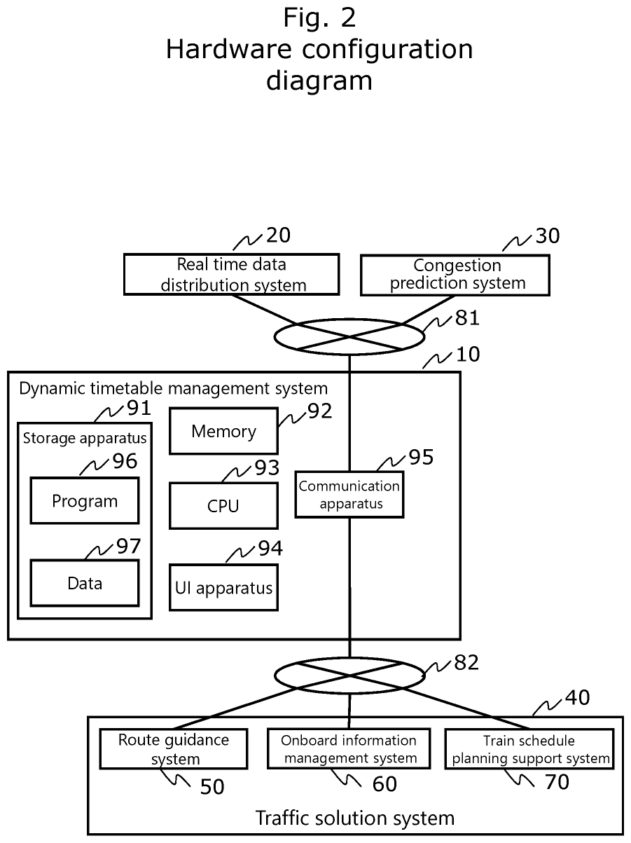

FIG. 2 shows a hardware configuration example of the dynamic timetable management system 10. The dynamic timetable management system 10 is made up of an apparatus capable of performing various information processing, that is, an information processing apparatus such as a computer as an example. The dynamic timetable management system 10 has a storage apparatus 91, a memory 92, a computation apparatus (hereinafter simply called a CPU) 93 as represented by a CPU, a UI apparatus 94, and a communication apparatus 95.

The computation apparatus 93 is, for example, a CPU (Central Processing Unit), a GPU (Graphic Processing Unit), a FPGA (Field-Programmable Gate Array), or the like. The storage apparatus 91 has, for example, a magnetic storage medium such as a HDD (Hard Disk Drive), a semiconductor storage medium such as a RAM (Random Access Memory), a ROM (Read Only Memory), and a SSD (Solid State Drive), or the like. Further, an optical disk such as a DVD (Digital Versatile Disk) and a combination of optical disk drives are also used as the storage apparatus 91. Besides, a known storage medium such as a magnetic tape medium is also used as the storage apparatus 91.

The storage apparatus 91 stores, besides a program 96 for implementing the function modules 100 to 108 (see FIG. 1) performed by the dynamic timetable management system 10, data necessary for performing the function modules or the data 109 to 113 (see FIG. 1) generated by the function modules or the like as data 97. When the operation of the dynamic timetable management system 10 starts (for example, when power is turned on), the program 96 is read from the storage apparatus 91 and developed and performed on the memory 92 to perform entire control of the dynamic timetable management system 10. Further, the storage apparatus 91 stores, besides the program 96, data 97 necessary for each processing of the dynamic timetable management system 10.

Alternatively, some of constituting elements configuring the dynamic timetable management system 10 may be coupled to each other via a LAN (Local Area Network) or a WAN (Wide Area Network) such as the Internet.

The memory 92 is a non-volatile memory such as a RAM. The CPU 93 calls the program 96 and the data 97 retained by the storage apparatus 91 into the memory 92, and performs the same. The UI apparatus 94 is coupled to an input apparatus such as a keyboard and a mouse or an output apparatus such as a display not shown, and realizes a GUI. The communication apparatus 95 performs communication processing with an outside relevant system via the network 81 or 82.

Note that the real time data distribution system 20, the congestion prediction system 30, and the traffic solution system 40 (including the route guidance system 50, the onboard information management system 60, and the train schedule planning support system 70) shown in FIG. 1 also have the same hardware configurations as those of the dynamic timetable management system 10.

Hereinafter, the function modules 100 to 107 and the data 109 to 113 of the dynamic timetable management system 10 shown in FIG. 1 will be described.

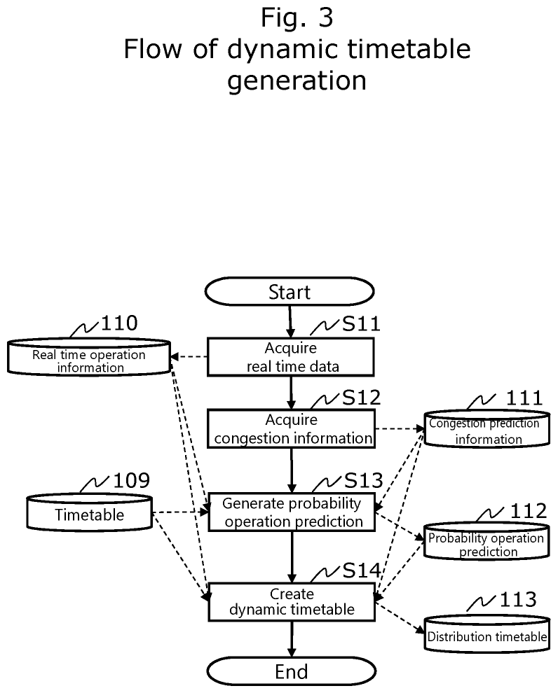

FIG. 3 is a processing flow of the entire dynamic timetable generation unit 100 (including the function modules 101 to 107). This processing may start at timing set in advance by the dynamic timetable management system 10, or may start, when the real time data distribution system 20 or the congestion prediction system 30 distributes data by PUSH type distribution, at the timing when the dynamic timetable management system 10 receives the data.

First, the real time data acquisition unit 101 acquires real time data from the real time data distribution system 20 (S11). At this time, the data is desirably cleansed and converted into a prescribed format. The data obtained here is stored as the real time operation information 110.

Next, the congestion information acquisition unit 102 acquires data from the congestion prediction system 30 (S12). At this time, the data is desirably cleansed and converted into a prescribed format. The data obtained here is stored as the congestion prediction information 111.

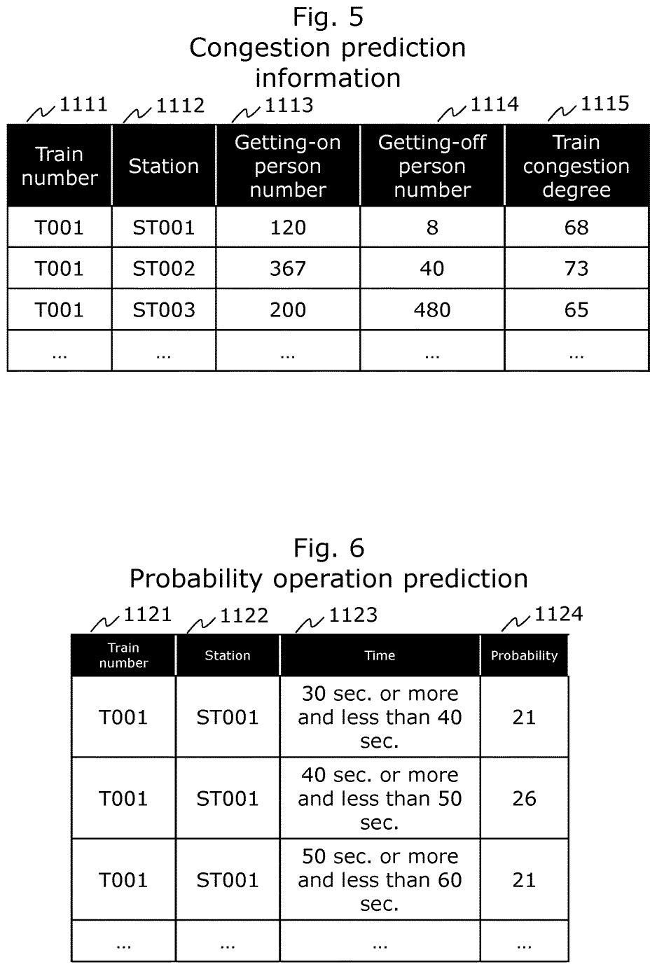

Here, FIG. 5 shows a data example of the congestion prediction information 111. The congestion prediction information 111 includes areas to store each value of a train number 1111, a station 1112, a getting-on person number 1113, a getting-off person number 1114, and a train congestion degree 1115. The train number 1111 is a name or an identification code for specifying a train. The station 1112 is a name or an identification code for specifying a station. The getting-on person number 1113 expresses the number of persons getting on a train at a station. The getting-off person number 1114 expresses the number of persons getting off a train at a station. The train congestion degree 1115 expresses a congestion degree when a train departs from a station, and is expressed as a percentage relative to the capacity of the train. Besides, the congestion prediction information can also include the calculated number of persons residing in each station for each time in combination with timetable data.

Next, the probability operation prediction generation unit 103 stochastically predicts future time information on a railway and generates the probability operation prediction 112 on the basis of the real time operation information 110, the congestion prediction information 111, and the timetable 109 stored in advance (S13).

FIG. 6 shows an example of the/probability operation prediction 112. Future time information on a railway shown in the probability operation prediction may be a departure time point or an arrival time point itself at a station, a travel time (a travel time of a train between stations), or a dwell time. Further, a required time for transfer in each line of each station, a waiting time in each bathroom, or the like may be defined. Here, a dwell time is shown as an example.

The probability operation prediction 112 includes areas to store each value of a train number 1121, a station 1122, a time 1123, and a probability 1124. The train number 1121 and the station 1122 are the same data as the train number 1111 and the station 1112. The time 1123 is a value predicted as a dwell time. The time 1123 is defined as a discrete value having a prescribed time width. The probability 1124 is a probability with which a dwell time becomes a value of the time 1123. In the present embodiment, the probability 1124 is expressed as a percentage, and a total value of the probabilities 1124 becomes 100 as for the same train number and the same station.

Here, any method can be used as a method for stochastically performing operation prediction. For example, a delay time may be predicted on the basis of the statistics of a past record, a change in a travel position may be predicted from the relationship of the travel position of a train, an extension/reduction of a delay may be predicted on the basis of the tendency of a delay time, or influence may be predicted from operation information on a line. Besides, prediction may be performed in consideration of influence by a station structure, a station type, a train type, a season, weather, a time slot, or the like. A plurality of methods may be combined together.

Finally, the dynamic timetable creation unit 104 extracts necessary information from the real time operation information 110 and the congestion prediction information 111, determines a rewritten time point of a timetable on the basis of the probability operation prediction 112, and rewrites the timetable 109 to generate the distribution timetable 113 (S14).

The flow of the entire dynamic time generation unit is described above.

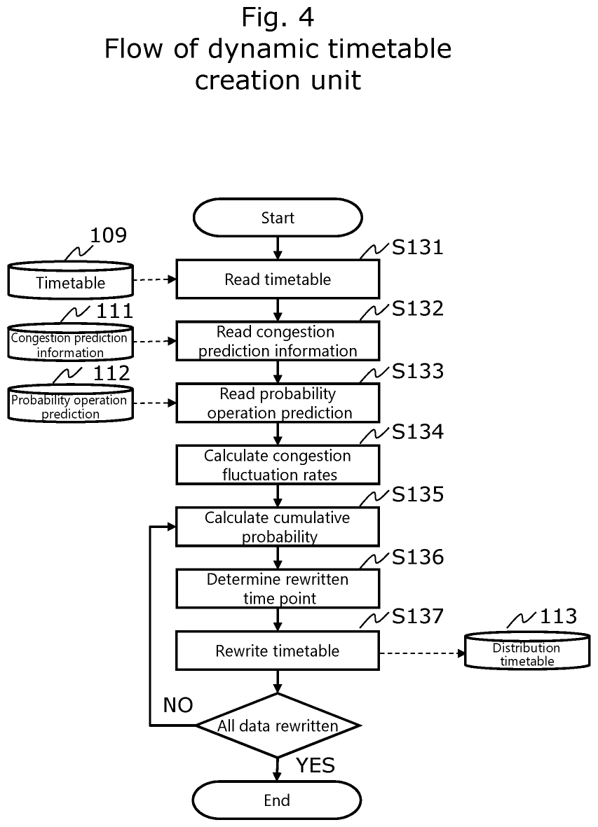

FIG. 4 is a detailed flowchart of dynamic timetable creation S14 performed by the dynamic timetable creation unit 104.

First, the dynamic timetable creation unit 104 reads the timetable 109, the congestion prediction information 111, and the probability operation prediction 112 necessary for creating a dynamic timetable (S131, S132, and S133).

Next, the cumulative probability generation unit 105 calculates congestion fluctuation rates (S134).

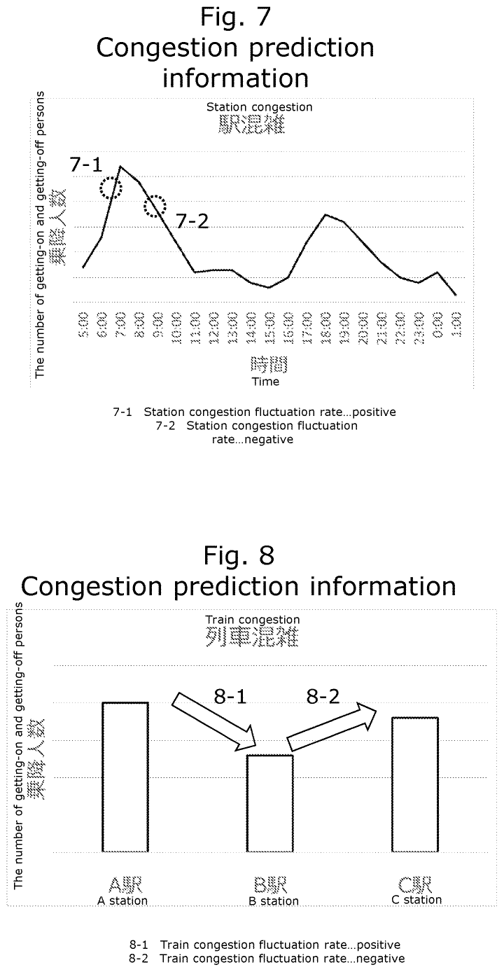

A calculation method will be described with reference to FIGS. 7 and 8. FIG. 7 is a graph obtained by calculating the number of getting-on and getting-off persons for each time slot at each station from the congestion prediction information 111.

FIG. 8 is a graph obtained by calculating from the congestion prediction information 111 the number of getting-on and getting-off persons for each station in each train. A congestion fluctuation rate indicates the proportion of a change in congestion in a time axis. For example, in FIG. 7, a calculated congestion fluctuation rate (hereinafter described as a “station congestion fluctuation rate”) at each station is expressed by the following formula.

A station congestion fluctuation rate=(the number of getting-on and getting-off persons after a lapse of a time−the number of getting-on and getting-off persons before the lapse of the time)/a lapsed time

Specifically, a part 7-1 in FIG. 7 shows that the number of getting-on and getting-off persons increases with time, and therefore the congestion fluctuation rate becomes a positive value. On the other hand, a part 7-2 in FIG. 7 shows that the number of getting-on and getting-off persons decreases with time, and therefore the congestion fluctuation rate becomes a negative value. Further, data is calculatable with any granularity from units of a few minutes to units of hours.

Moreover, the calculation method for the station congestion fluctuation rate is not limited to the above. However, an inclination may be calculated in such a manner as to express the number of getting-on and getting off persons in units of certain times by a formula and differentiate the formula.

In FIG. 8, a congestion fluctuation rate (hereinafter described as a “train congestion fluctuation rate”) of each train is expressed by the following formula.

A train congestion fluctuation rate=(the number of getting-on and getting-off persons at a station preceding by n−the number of getting-on and getting-off persons at the station concerned)/n

Specifically, a part 8-1 in FIG. 8 shows that the number of getting-on and getting-off persons at a B station is smaller than that at a station A, and therefore the congestion fluctuation rate becomes a negative value. On the other hand, a part 8-2 in FIG. 8 shows that the number of getting-on and getting-off persons at a C station is larger than that at the station B, and therefore the congestion fluctuation rate becomes a positive value.

Next, the cumulative probability generation unit 105 calculates a cumulative probability on the basis of the above congestion fluctuation rates (S135).

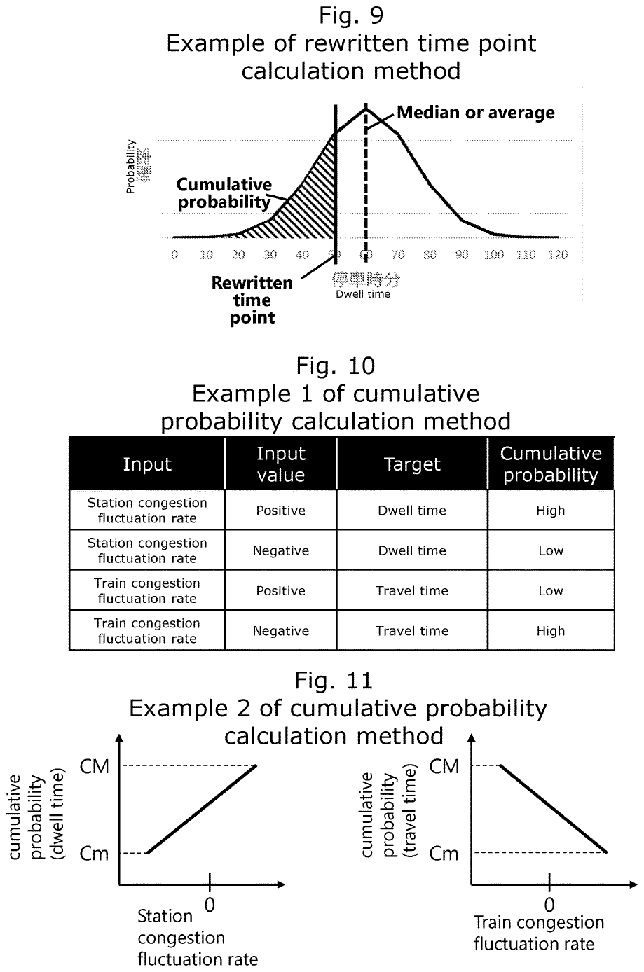

The calculation of a cumulative probability will be described with reference to FIGS. 9, 10, 11, 12, and 13.

FIG. 9 is a graph showing a probability distribution with the time 1123 and the probability 1124 of the probability operation prediction 112 set in a horizontal axis and a vertical axis, respectively. Here, a dwell time is assumed as the time of the horizontal axis, but a target time is not limited to the dwell time as described above. In rewriting a timetable, it is necessary to uniquely determine a rewritten time point at which the timetable is actually rewritten from the probability distribution. A cumulative probability expresses an area obtained by stacking probability values of the probability distribution until the rewritten time point, and takes a value of 0 to 100%. Here, in other words, the rewritten time point can be calculated on the basis of the cumulative probability when the cumulative probability is determined. The rewritten time point increases as the cumulative probability becomes higher, and decreases as the cumulative probability becomes lower. If the probability distribution follows a normal distribution, the rewritten time point at which the probability value becomes maximum when the cumulative probability is 50% can be acquired.

FIG. 10 is a table showing a cumulative probability determination method. For example, when a station congestion fluctuation rate is positive, the number of getting-on and getting off persons further increases with time once a delay is caused and a dwell time further increases. Accordingly, a cumulative probability relating to the dwell time becomes high. When the station congestion fluctuation rate is negative, the number of getting-on and getting off persons decreases with time even when a delay is caused. Therefore, the delay has less influence on the dwell time. Accordingly, the cumulative probability relating to the dwell time becomes low. When a train congestion fluctuation rate is positive, an operator makes an effort to arrive at a next station earlier so as to avoid a delay caused by future congestion based on his/her experience. Accordingly, a cumulative probability relating to a travel time between stations becomes low. Conversely, when the train congestion fluctuation rate is negative, the operator performs travel with a sufficient time allowance expecting that a delay caused by congestion will be eliminated based on his/her experience. Accordingly, the cumulative probability relating to the travel time between the stations becomes high.

FIG. 11 is a graph of a cumulative probability calculation method described above. The relationship between a station congestion fluctuation rate and a cumulative probability relating to a dwell time can be expressed like, for example, a linear function having a positive inclination since the cumulative probability becomes higher as the station congestion fluctuation rate increases. In this case, a fluctuation (a maximum value CM to a minimum value Cm) of the cumulative probability relating to the dwell time may be set at 0 to 100% or any value. Further, a function other than a linear function may be used in accordance with the characteristics of a service provider. The relationship between a train congestion fluctuation rate and a cumulative probability relating to a travel time can be expressed like, for example, a linear function having a negative inclination since the cumulative probability becomes lower as the train congestion fluctuation rate increases. Similarly, a fluctuation (a maximum value CM to a minimum value Cm) of the cumulative probability relating to the travel time may also be set at 0 to 100% or any value. Further, a function other than a linear function may be used in accordance with the characteristics of a service provider.

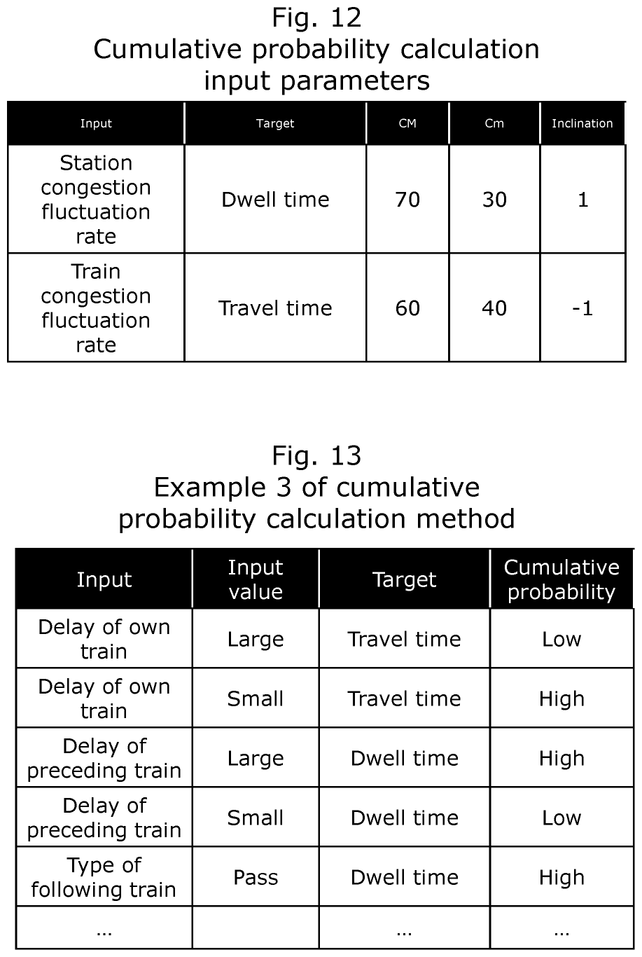

FIG. 12 shows an example of parameters necessary for calculating a cumulative probability. Here, the parameters are shown assuming that the relationship between the cumulative probability and each congestion fluctuation rate is expressed as a first-order linear function. As described in the calculation method described above, the cumulative probability generation unit 105 requires a time targeted by a cumulative probability calculated from each fluctuation rate, a fluctuation (a maximum value CM to a minimum value Cm) of the cumulative probability, and an inclination that is a first-order coefficient as input parameters. Note that in this example, each congestion fluctuation rate is normalized in accordance with a fluctuation of the cumulative probability at the time of calculating the cumulative probability, and 1 or −1 is input as an inclination. Further, the above is given only as an example. When the relationship between a cumulative probability and each congestion fluctuation rate is expressed as a multi-order linear function, input coefficients are increased. When the relationship is not expressed as a linear function, a function itself may be used as an input parameter.

The method for calculating a cumulative probability relating to a dwell time using a station congestion fluctuation rate and the method for calculating a cumulative probability relating to a travel time using a train congestion fluctuation rate are described above. Similarly, cumulative probabilities relating to other times on railways are also calculatable. For example, when a station congestion fluctuation rate is positive, it is presumed that a station yard is put in a state of more chaos by a delay. Therefore, it is presumed that a cumulative probability relating to a required time for transfer becomes high.

Further, a cumulative probability is calculated using a congestion fluctuation rate, but it is presumed that the cumulative probability is calculated in consideration of various other factors.

FIG. 13 shows an example of the various factors. For example, when an own train that is a timetable rewriting target is delayed, a travel time is shortened to recover the delay. To this end, a cumulative probability relating to the travel time is made lower as the delay of the own train is larger, whereby it is possible to rewrite the timetable so as to obtain a time point reflecting operator's intension more precisely. Further, when a train preceding a train that is a timetable rewriting target is delayed, it is highly likely that a dwell time is prolonged to adjust an interval. Therefore, a cumulative probability relating to the dwell time is made higher as the delay of the preceding train is larger, whereby it is possible to rewrite the timetable so as to correspond to delay factors other than congestion. Moreover, when a train following a train that is a timetable rewriting target does not stop at a rewriting target station, it is presumed that the number of persons trying to get on the train that is the rewriting target is increased, and that a dwell time is prolonged. Therefore, a cumulative probability relating to the dwell time is increased when the following train passes through the station, whereby it is possible to rewrite the timetable reflecting passengers' needs on the delay caused by congestion.

Besides the factors described above, a cumulative probability relating to a travel time is calculated in consideration of the presence or absence of a post-operation to enable reflection of operator's intension more precisely, a cumulative probability relating to a dwell time is calculated in consideration of a type of an own train to enable reflection of the need of the own train, cumulative probabilities relating to a travel time and a dwell time are calculated in consideration of the delay of a line at a transfer destination to enable reflection of operator's intension more precisely, and a cumulative probability relating to a dwell time is calculated in consideration of the delays of other linked-up lines to enable reflection of the influence of congestion by the other lines. As described above, provision of various factors at the time of determining a cumulative probability enables creation of a timetable closer to actual situations.

When these factors are taken into consideration in accordance with a congestion fluctuation rate, it is possible to deal with the plurality of factors by expressing a cumulative probability as a linear function having an increased dimension corresponding to the target factors, but a method is not limited to this. When these factors are used, a fluctuation (a maximum value CM to a minimum value Cm) and a coefficient or a function of a cumulative probability corresponding to each input are input as shown in FIG. 12. When a cumulative probability is calculated with respect to a plurality of same target factors, the influence of each factor may be input as a weight parameter.

Next, a rewritten time point determination unit 106 determines a rewritten time point on the basis of the cumulative probability (S136). A method for determining the rewritten time point is described above using FIG. 9.

Finally, a timetable rewriting unit 107 rewrites a timetable using the determined rewritten time point or a median or an average of a probability distribution to generate the distribution timetable 113 (S137).

The calculation of the cumulative probability (S135), the determination of the rewritten time point (S136), and the rewriting of the timetable (S137) are sequentially performed for each train/station sorted in a time series manner. In the rewriting of the timetable, some restrictions are imposed so that the order of trains is not changed or a departure time from a station is not made earlier ahead of a schedule. For example, if a preceding train is overtaken when a timetable is rewritten in line with a rewritten time point of a travel time, the rewritten time point is replaced so that a value becomes closest to the rewritten time point in a range in which the preceding train is not overtaken. This processing is repeatedly performed until all timetables are rewritten.

During the repetition, it is also possible to calculate a cumulative probability on the basis of a rewritten portion of a timetable.

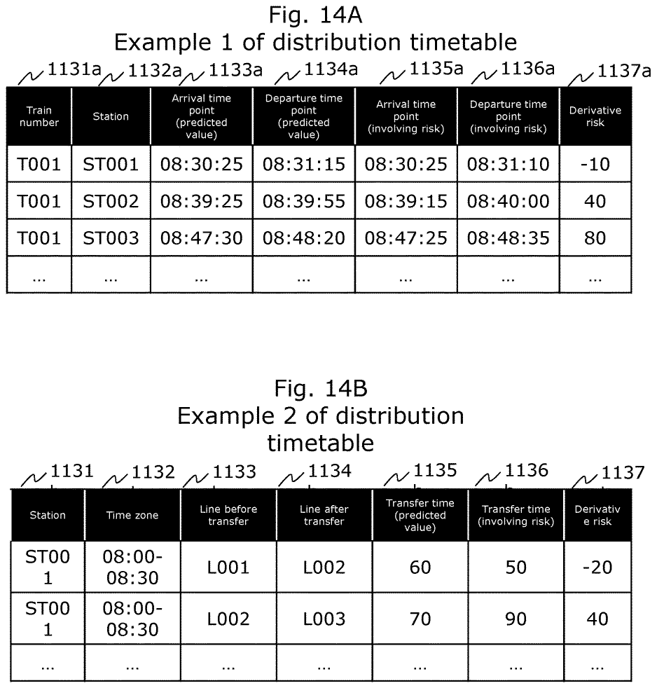

FIGS. 14A and 14B show data structure example of a generated distribution timetable.

As shown in FIG. 14A, the distribution timetable 113 includes areas to store each value of a train number 1131a, a station 1132a, an arrival time point (predicted value) 1133a, a departure time point (predicted value) 1134a, an arrival time point (involving a risk) 1135a, a departure time point (involving a risk) 1136a, and a derivative risk 1137a.

The train number 1131a is a name or an identification code for specifying a train. The station 1132a is a name or an identification code for specifying a station. The arrival time point (predicted value) 1133a indicates an arrival time point of the train concerned or the station concerned obtained when a timetable is rewritten by a median or an average of the probability operation prediction 112. The departure time point (predicted value) 1134a indicates a departure time point obtained when the timetable is similarly rewritten by a median or a predicted value. The arrival time point (involving a risk) 1135a indicates an arrival time point obtained when the timetable is rewritten using a rewritten time point determined from a cumulative probability. The departure time point (involving a risk) 1136a indicates a departure time point obtained when the timetable is similarly rewritten using a rewritten time point. The derivative risk 1137a is calculated using a cumulative probability. For example, a derivative risk is calculated as −100 to 0 when a cumulative probability is 0 to 50%, and calculated as 0 to 100 when the cumulative probability is 50% to 100%. In the derivative risk 1137a, various derivative risks such as a derivative risk with respect to a dwell time, a derivative risk with respect to a travel time until a next station, and a derivative risk with respect to a delay time of a departure time point are capable of being stored. When a plurality of derivative risks are calculated, it is necessary to increase an area to store the derivative risks.

Further, when a value such as a required time for transfer that is not directly linked to a timetable is calculated, the distribution timetable 113 includes a station 1131b, a time slot 1132b, a line 1133b before transfer, a line 1134b after transfer, a transfer time (predicted value) 1135b, a transfer time (involving a risk) 1136b, and a derivative risk 1137b as shown in FIG. 14B.

The station 1131b is a name or an identification code for specifying a station. The time slot 1132b is set in accordance with a fluctuation of a required time for transfer. The line 1133b before transfer is a name or an identification code for specifying a line before transfer when changing trains at a station indicated by the station 1131b. The line 1134b after transfer is a name or an identification code for specifying a line after transfer when changing trains at a station indicated by the station 1131b. The transfer time (predicted value) 1135b stores a median or an average of the probability operation prediction 112 predicting a required time for transfer. The transfer time (involving a risk) 1136b stores a rewritten time point determined at the time of determining the rewritten time point (S136). The derivative risk 1137b is the same as the derivative risk 1137a.

The flow of the dynamic timetable creation unit 104 is described above.

The function modules 100 to 107 and the data 109 to 113 are described above.

Subsequently, the effect of the distribution timetable 113 on the traffic solution system 40 will be described in detail.

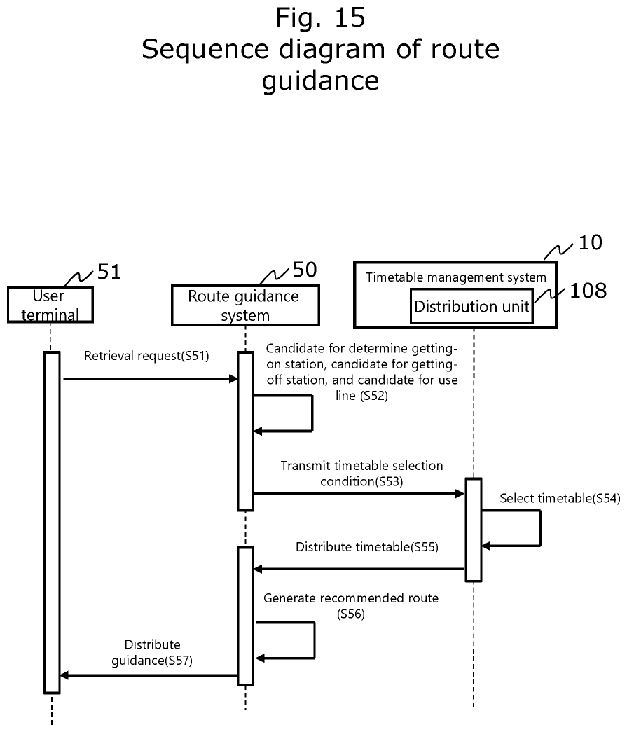

First, the interface of the user terminal 51, the route guidance system 50, and a distribution unit 108 of the dynamic timetable management system 10 will be described using FIG. 15.

First, the user terminal 51 transmits a route search request to the route guidance system 50 (S51). In the search request, a condition such as a departure station (getting-on station), a destination station (getting-off station), and a use date and time is input and transmitted. Note that the search request may be transmitted at any timing by an individual user, or may be transmitted in accordance with a schedule set in advance like each fixed time.

Next, the route guidance system 50 determines, in consideration of transfer, a candidate for a line and a candidate for a getting-on station and a candidate for a getting-off station for each line corresponding to the search request (S52). Here, route search using a static timetable is only required to be performed to determine the candidates. The route guidance system 50 transmits information on the line, the getting-on station, the getting-off station, the use date/time determined here to the dynamic timetable management system 10 as a timetable selection condition (S53).

Upon receiving the timetable selection condition from the route guidance system 50, the distribution unit 108 of the dynamic timetable management system 10 selects a timetable to be distributed (S54). As the timetable to be distributed, the timetable 109 corresponding to a static timetable or the distribution timetable 113 corresponding to a dynamic timetable is stored in the dynamic timetable management system 10. The distribution unit 108 distributes the dynamic timetable if the dynamic timetable has been generated, or distributes the static timetable if the dynamic timetable has not been generated. Note that the route guidance system 50 is presumed to generally retain the static timetable. Therefore, the static timetable may not be distributed but is only required to be informed.

The distribution unit 108 of the dynamic timetable management system 10 distributes the timetable to the route guidance system 50 (S55). The route guidance system 50 generates a recommended route using the received timetable (S56), and distributes guidance based on the recommended route to the user terminal 51 (S57).

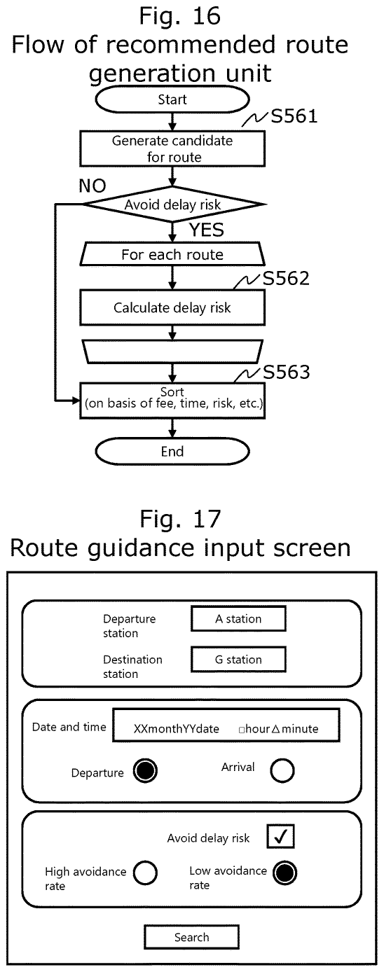

FIG. 16 shows a flowchart of the generation of a recommended route (S56).

First, the route guidance system 50 generates a candidate for a route from a departure station, a destination station, a use date and time, or the like again on the basis of a received timetable (S561). When having been requested to make a search to avoid a delay risk from a user terminal, the route guidance system 50 calculates the delay risk for each route (S562). In the calculation of the delay risk, the route guidance system 50 uses the derivative risks 1137a and 1137b included in the distribution timetable 113. After that, the route guidance system 50 can generate a recommended route by sorting each route on the basis of a delay risk, a use fee, a required time, or the like (S563).

FIG. 17 shows an example of an input screen displayed when the user terminal 51 transmits a search request to the route guidance system 50 (S51).

As a user operating the user terminal 51, a general passenger using a railway or a bus is assumed. This input screen includes a use station input segment, a use date and time input segment, and a delay risk avoidance input segment. The user is enabled to input a departure station and a destination station to the use station input segment, input a use date and time and classification as a departure or an arrival to the use date and time input segment, and input the necessity of route guidance avoiding a delay risk to the delay risk avoidance input segment. In the delay risk avoidance input segment, buttons for selecting avoidance rates exist. When the user selects a “high avoidance rate,” a search request placing the highest priority on avoidance of a delay risk is transmitted. When the user selects a “low avoidance rate,” a search request considering a required time or a fee besides a delay risk is transmitted. Besides, the input screen may include an input segment to which an item (such as, for example, a through station, use of an express train, and a time allowance for transfer) provided in a general route search service is input. A value and user information or a search time point input here are transmitted to the route guidance system 50 as a search request.

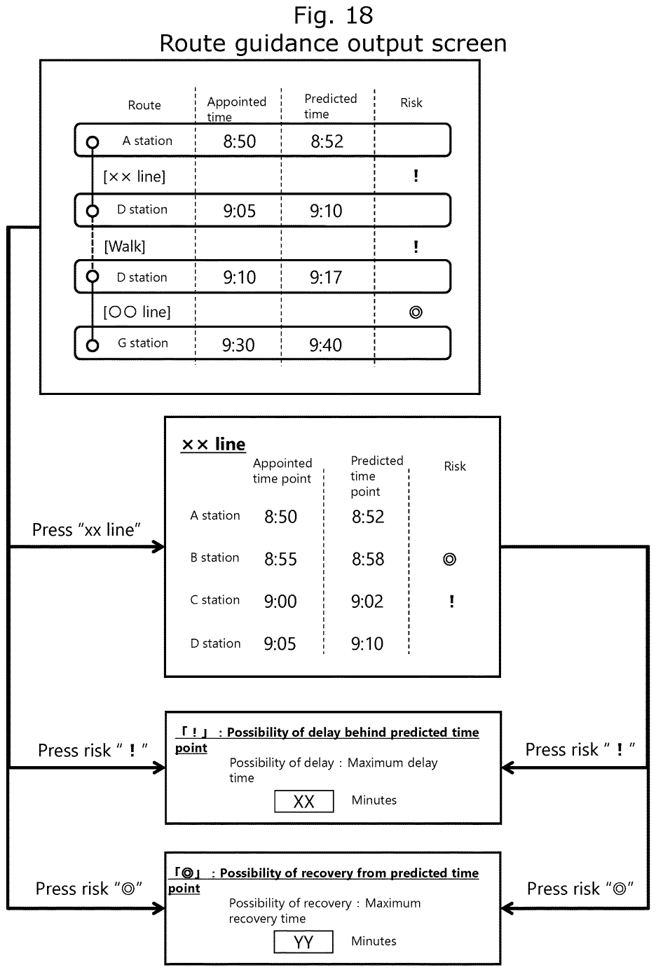

FIG. 18 shows an example of a screen output when the user terminal 51 receives guidance distribution (S57) from the route guidance system 50.

In this screen, arrival time points at each station are displayed in a table form. Segments of a route, an appointed time point, a predicted time point, and a risk exist. Station names and moving means such as use lines are displayed in the route segment, arrival and departure time points in a case in which a static timetable is used are displayed in the appointed time point segment, arrival and departure time points in a case in which the arrival time points (predicted values) 1133a and the departure time points (predicted values) 1134a in the distribution timetable 113 are used are displayed in the predicted time point segment, and marks such as “!” and “⊚” indicating involvement of any risk are displayed in the risk segment.

After a use line in the route segment is pressed, arrival time points or departure time points at totally four stations including intermediate B and C stations are displayed when the user gets on a train in a range in which the user gets on the use line, for example, from an A station to a D station.

Arrival and departure time points in a case in which the static timetable is used are displayed in the appointed time point segment. Arrival and departure time points in a case in which the arrival time points (predicted values) 1133a and the departure time points (predicted values) 1134a in the distribution timetable 113 are used are displayed in the predicted time point segment. Marks such “!” and “⊚” indicating involvement of any risk are displayed in the risk segment.

When “!” is pressed in the risk segment, information indicating “the possibility of a delay behind a predicted time point” is displayed, and the possibility of a maximum delay time behind the predicted time point is displayed. The time displayed here is the difference between a time from the arrival time point (involving a risk) 1135a to the departure time point (involving a risk) 1136a and a time from the arrival time point (predicted value) 1133a to the departure time point (predicted value) 1134a in the distribution timetable 113.

When “⊚” is pressed in the risk segment, information indicating “the possibility of recovery from a predicted time point” is displayed, and the possibility of a maximum recovery time from the predicted time point is displayed. The time displayed here is the difference between a time from the arrival time point (involving a risk) 1135a to the departure time point (involving a risk) 1136a and a time from the arrival time point (predicted value) 1133a to the departure time point (predicted value) 1134a in the distribution timetable 113. The presence or absence of the display of these risks is determined according to the values of the derivative risks 1137a and 1137b in the distribution timetable 113.

Further, the marks “!” and “⊚” and the displayed text are given only as an example, and uses of other display methods are also possible.

By referring to the screens exemplified in FIGS. 17 and 18, passengers are enabled to acquire, even in any line including unknown regions, guidance information based on operation predictions closer to actual situations in consideration of the influence of delays caused by congestion and act while comparing appointed time points and the predicted time points with each other and quantitatively grasping delay risks.

Similarly, the onboard information management system 60 and the train schedule planning support system 70 perform each processing through each interface but will be described only on the basis of each screen.

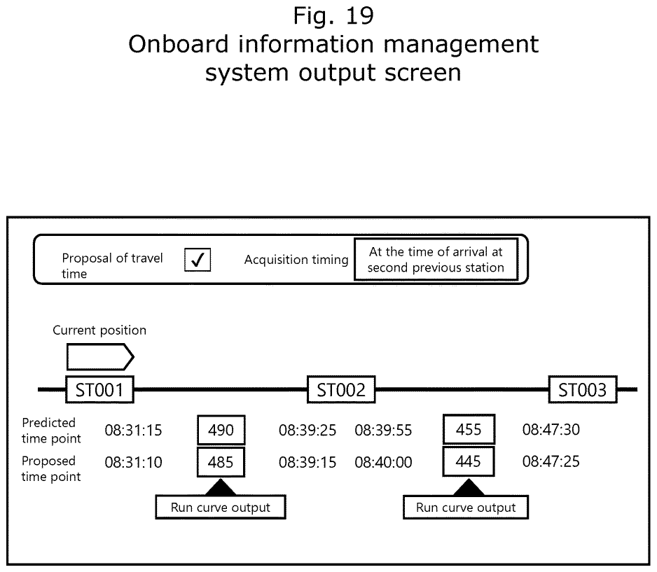

FIG. 19 shows an input/output screen of the user terminal 61 directed to the onboard information management system 60.

The user terminal 61 is enabled to select the necessity of travel time proposal and proposal acquisition timing as inputs. In accordance with the timing selected here, the user terminal 61 transmits a proposal request to the onboard information management system 60.

The onboard information management system 60 having received a proposal request receives the corresponding distribution timetable 113 from the dynamic timetable management system 10, and transmits arrival and departure times and travel times included in the distribution timetable 113 and operation support information created on the basis of the arrival and departure times and the travel times to the user terminal 61.

On the user terminal 61, predicted time points and proposed time points at each station are displayed. As the predicted time points, time points using the arrival time points (predicted values) 1133a and the departure time points (predicted values) 1134a in the distribution timetable 113 and travel times calculated from the arrival time points 1133a and the departure time points 1134a are displayed. As the proposed time points, time points using the arrival time points (involving a risk) 1135a and the departure time points (involving a risk) 1136a in the distribution timetable 113 and travel times calculated from the arrival time points 1135a and the departure time points 1136a are displayed. The user terminal 61 is also enabled to display other operation support information such as a run curve output button.

By referring to the screen exemplified in FIG. 19, operators are enabled to acquire quantitative operation support information based on operation predictions closer to actual situations in consideration of the influence of delays caused by congestion and run train to contribute to elimination of the delays. Here, in a case in which the information acquired by the user terminal 61 is input to the automatic operation apparatus 62 instead, automatic operation contributing to the elimination of delays is enabled based on operation predictions closer to actual situations in consideration of the influence of delays.

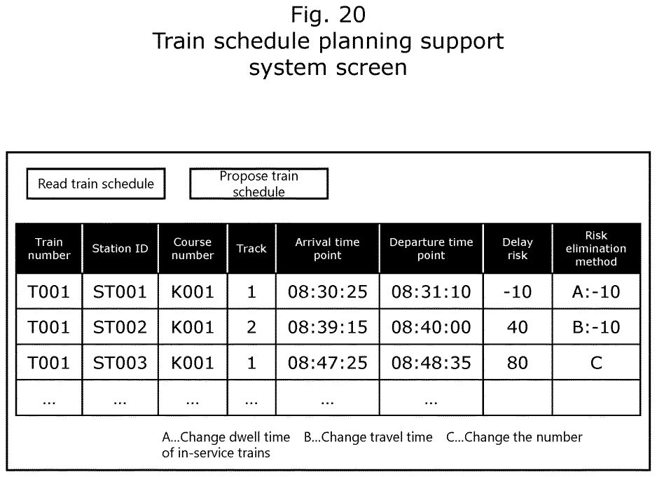

FIG. 20 shows an input/output screen of the user terminal 71 directed to the train schedule planning support system 70.

The user terminal 71 receives a train schedule forming the base of a basic train schedule, and transmits a train schedule proposal request to the train schedule planning support system 70 when a proposal button is pressed.

The train schedule planning support system 70 proposes a risk elimination method based on a delay risk on the basis of the distribution timetable 113 received from the dynamic timetable management system 10, and transmits the distribution timetable 113 and the risk solution method to the user terminal 71.

A timetable is output to the user terminal 71. The arrival time points (involving a risk) 1135a and the departure time points (involving a risk) 1136a in the distribution timetable 113 are applied to arrival time point/departure time point segments, and delay risks based on the derivative risks 1137a are stored in a delay risk segment. When there are a plurality of derivative risks, new delay risks may be calculated on the basis of the derivative risks, or a plurality of delay risk segments may be created and displayed. As the risk elimination methods, risk elimination methods based on the delay risks are displayed. For example, information such as increasing a dwell time by 10 seconds, decreasing a travel time by 10 seconds, and changing the number of in-service trains is written.

By referring to the screen exemplified in FIG. 20, persons in charge of a railway sales department are enabled to quantitatively grasp the influence of delays caused by congestion and create basic train schedules capable of absorbing the influence of delays caused by the congestion.

As described above, according to the present embodiment, a dynamic timetable is generated in consideration of the influence of delays caused by congestion to enable predictions of future delays in a manner closer to actual measurement, and distributed to the traffic solution system 40 to enable solutions considering the influence of delays.

Note that the above embodiments describe the configurations in detail to clearly understand the present invention, but the present invention is not necessarily required to include all the configurations. Further, some of the configurations of the respective embodiments may be added to, deleted from, or replaced with other configurations.

Further, some or all of the above configurations, the processing units, the processing means, or the like may be realized as hardware by being designed as, for example, integrated circuits. Further, the present invention can also be realized by a program software code of software that realizes the functions of the embodiments. In this case, a storage medium storing the program code is recorded is provided to a computer, and a processor provided in the computer reads the program code stored in the storage medium. Here, the program code itself read from the storage medium realizes the functions of the embodiments described above, and the program code itself and the storage medium storing the program code configure the present invention. As such a storage medium for supplying the program code, a flexible disk, a CD-ROM, a DVD-ROM, a hard disk, a SSD (Solid State Drive), an optical disk, an optical magnetic disk, a CD-R, a magnetic tape, a non-volatile memory card, a ROM, or the like is used.

Further, the program code realizing the functions described in the present embodiment can be implemented by a wide range program or script language such as assembler, C/C++, perl, Shell, PHP, Java (TM), and Python.

Moreover, all or a part of the program code of the software that realizes the functions of the respective embodiments may be stored in advance in the storage apparatus 91, or may be stored in the storage apparatus 91 from a non-transitory storage apparatus of another apparatus coupled to a network or from a non-transitory storage medium via an external I/F not shown of the dynamic timetable management system 10 where necessary.

Moreover, the program code of the software that realizes the functions of the embodiments may be distributed via a network to be stored in storage means such as a hard disk and a memory of a computer or a storage medium such as a CD-RW and a CD-R, so that a processor provided in the computer reads and runs the program code stored in the storage means or the storage medium.

In the above embodiments, control lines or information lines are shown as being necessary for descriptions. All the control lines or information lines are not necessarily shown in terms of a product. All the configurations may be coupled to each other.

### REFERENCE SIGNS LIST

10 Dynamic timetable management system
20 Real time data distribution system
30 Congestion prediction system
81, 82 Network
91 Storage apparatus
92 Memory
93 CPU
100 Dynamic timetable generation unit
101 Real time data acquisition unit
102 Congestion information acquisition unit
103 Probability operation prediction generation unit
104 Dynamic timetable creation unit
105 Cumulative probability generation unit
106 Rewritten time point determination unit
107 Timetable rewriting unit
108 Distribution unit
109 Timetable
110 Real time operation information
111 Congestion prediction information
112 Probability operation prediction
113 Distribution timetable

1.-12. (canceled)

13. A dynamic timetable management system generating a dynamic timetable reflecting an operation situation and a congestion prediction of a movable body in a line including a plurality of stops, the dynamic timetable management system comprising:
a congestion information acquisition unit configured to acquire the congestion prediction;
a probability operation prediction generation unit configured to generate, on a basis of the operation situation, a probability operation prediction in which at least one of a dwell time and a travel time included in the line is expressed as a probability distribution; and
a dynamic timetable creation unit configured to create, on a basis of a rewritten time point set using the congestion prediction and the probability operation prediction, the dynamic timetable in which a time point of arrival at each of the stops and a time point of departure from each of the stops included in the line are rewritten, wherein
the dynamic timetable creation unit is configured to calculate, on a basis of a congestion fluctuation rate that is calculated from the congestion prediction and fluctuates over time, a cumulative probability so that the cumulative probability relating to the dwell time becomes higher as the congestion fluctuation rate at each of the stops increases, and so that the cumulative probability relating to the travel time becomes lower as the congestion fluctuation rate in each of the movable bodies increases, and determine the rewritten time point using the calculated cumulative probability.

14. The dynamic timetable management system according to claim 13, wherein
the dynamic timetable creation unit is configured to use, with a linear function being a formula for converting each of the congestion fluctuation rates into the cumulative probability, input a maximum value of the cumulative probability, a minimum value of the cumulative probability, and a first-order coefficient as parameters so as to derive the linear function.

15. The dynamic timetable management system according to claim 14, wherein
the dynamic timetable creation unit is configured to calculate the cumulative probability by using the congestion fluctuation rate and one or more of: presence or absence of a delay of the movable body as a target for which the rewritten time point is provided; a type of the movable body; a type of the movable body that follows a movable body; presence or absence of a post-operation; a delay of the movable body traveling ahead of the movable body as a target; a delay of the line at a transfer destination; a time slot; and delays of other linked-up lines.

16. The dynamic timetable management system according to claim 13, wherein
the probability operation prediction generation unit is configured to generate the probability operation prediction in terms of a delay time, a required time for transfer, and a bathroom waiting time, and
the dynamic timetable creation unit is configured to generate a table showing the rewritten time point set using the congestion prediction and the probability operation prediction, instead of the dynamic timetable.

17. The dynamic timetable management system according to claim 13, comprising:
a distribution unit configured to, when receiving a timetable distribution condition from an external traffic solution system, distribute the dynamic timetable that matches the timetable distribution condition to the traffic solution system.

18. The dynamic timetable management system according to claim 17, wherein
the distribution unit is configured to distribute the dynamic timetable that matches a timetable selection condition to a route guidance system when receiving the timetable selection condition including a search target line and the stops for boarding and the stops for disembarking in the search target line from the route guidance system.

19. The dynamic timetable management system according to claim 17, wherein
the distribution unit is configured to distribute the dynamic timetable that matches a timetable selection condition to an onboard information management system when receiving from the onboard information management system, the timetable selection condition including the movable body as a search target and a condition on the plurality of stops in the movable body as the search target.

20. The dynamic timetable management system according to claim 17, wherein
the distribution unit is configured to distribute the dynamic timetable to a train schedule creation support system when receiving, from the train schedule creation support system, a timetable as a rewritten target.

21. A dynamic timetable management method by a dynamic timetable management system generating a dynamic timetable reflecting an operation situation and a congestion prediction of a movable body in a line including a plurality of stops, the dynamic timetable management method comprising:
acquiring the congestion prediction;
generating, on a basis of the operation situation, a probability operation prediction in which at least one of a dwell time and a travel time included in the line is expressed as a probability distribution; and
creating, on a basis of a rewritten time point set using the congestion prediction and the probability operation prediction, the dynamic timetable in which a time point of arrival at each of the stops and a time point of departure from each of the stops included in the line are rewritten, wherein
the rewritten time point is determined using a cumulative probability calculated on a basis of the congestion prediction, and
the cumulative probability is calculated on a basis of a congestion fluctuation rate that is calculated from the congestion prediction and fluctuates over time so that the cumulative probability relating to the dwell time becomes higher as the congestion fluctuation rate at each of the stops increases, and so that the cumulative probability relating to the travel time becomes lower as the congestion fluctuation rate in each of the movable bodies increases.

22. A traffic solution system using a dynamic timetable management system, wherein
the dynamic timetable management system is configured to generate a dynamic timetable reflecting an operation situation and a congestion prediction of a movable body in a line including a plurality of stops,
the dynamic timetable management system includes
a congestion information acquisition unit configured to acquire the congestion prediction,
a probability operation prediction generation unit configured to generate, on a basis of the operation situation, a probability operation prediction in which at least one of a dwell time and a travel time included in the line is expressed as a probability distribution,
a dynamic timetable creation unit configured to create, on a basis of a rewritten time point set using the congestion prediction and the probability operation prediction, the dynamic timetable in which a time point of arrival at each of the stops and a time point of departure from each of the stops included in the line are rewritten, and
a distribution unit configured to, when receiving a timetable distribution condition from the traffic solution system, distribute the dynamic timetable that matches the timetable distribution condition to the traffic solution system, and
the dynamic timetable creation unit is configured to calculate, on a basis of a congestion fluctuation rate that is calculated from the congestion prediction and fluctuates over time, a cumulative probability so that the cumulative probability relating to the dwell time becomes higher as the congestion fluctuation rate at each of the stops increases, and so that the cumulative probability relating to the travel time becomes lower as the congestion fluctuation rate in each of the movable bodies increases, and determine the rewritten time point using the calculated cumulative probability.
